(19) United States
(12) Patent Application Publication
(10) Pub. No.: US 2026/0004492 A1
(43) Pub. Date: Jan. 1, 2026

(54) EFFECT PRODUCTION METHOD, ELECTRONIC DEVICE AND STORAGE MEDIUM

(71) Applicant: Beijing Zitiao Network Technology Co., Ltd., Beijing (CN)

(72) Inventors: Shengru WANG, Beijing (CN); Hantong XU, Beijing (CN); Siming CHEN, Beijing (CN)

(21) Appl. No.: 19/257,051

(22) Filed: Jul. 1, 2025

(30) Foreign Application Priority Data
Jul. 1, 2024 (CN) 202410875051.2

(51) Int. Cl. G06T 11/60; G06F 3/0482; G06F 3/04845; G06F 3/04847; G06T 13/80

(52) U.S. Cl. CPC G06T 11/60; G06F 3/0482; G06F 3/04845; G06F 3/04847; G06T 13/80

(57) ABSTRACT

Embodiments of the present disclosure provide an effect production method, an electronic device and a storage medium. The method includes: displaying a created object on an effect production interface, and displaying an object production configuration panel triggered for the object; receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; invoking and running, after a production trigger condition of a content generated effect is satisfied, a resource package of the content generated resource, and performing content generation processing on the object to obtain the content generated effect.

### CROSS-REFERENCE TO RELATED APPLICATION

The present application claims priority of Chinese Patent Application No. 202410875051.2, filed on Jul. 1, 2024, and the entire content disclosed by the Chinese patent application is incorporated herein by reference as part of the present application for all purposes under the U.S. law.

### TECHNICAL FIELD

Embodiments of the present disclosure relates to the technical field of effect production, and in particular, to an effect production method, an electronic device and a storage medium.

### BACKGROUND

At present, a target image can be processed by image generation technology, so as to generate an effect image with creative effect after editing and creating the target image.

In an existing implementation, the related algorithms involved in image generation technology are deployed on the server end. When the user at the creation end has a request for creating and generating effect images, it is necessary to set the generation description information and some generation parameter information for generating effect images in advance.

For creators, when creating effect images, they must know how to set the generation description information and the generation parameter information in code form, and the setting of these information often requires creators to have a certain programming foundation. Therefore, the existing implementation of creating effect images has a high creation difficulty, and its usability is poor, making it difficult to popularize among non-professional people.

### SUMMARY

The present disclosure provides an effect production method and apparatus, a device and a storage medium.

An embodiment of the present disclosure provides an effect production method, comprising:
displaying a created object on an effect production interface, and displaying an object production configuration panel triggered for the object;
receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface;
invoking and running, after a production trigger condition of a content generated effect is satisfied, a resource package of the content generated resource, and performing content generation processing on the object to obtain the content generated effect.

An embodiment of the present disclosure provides an apparatus for producing an effect, comprising:
a display module, configured to display a created object on an effect production interface, and display an object production configuration panel triggered for the object;
a receiving module, configured to receive a content generated effect production operation, wherein the content generated effect production operation is selecting a content generated effect production item from the object production configuration panel, the content generated effect production item is associated with a constructed content generated resource, and the content generated resource is displayed in a resource list of the effect production interface;
an effect generation module, configured to invoke and run, after a production trigger condition of a content generated effect is satisfied, a resource package of the content generated resource, and perform content generation processing on the object to obtain the content generated effect.

An embodiment of the present disclosure also provides an electronic device, comprises:
one or a plurality of processors;
a storage apparatus, configured to store one or a plurality of programs, wherein
when the one or plurality of programs are executed by the one or plurality of processors, the one or plurality of processors are caused to implement the effect production method provided by the above embodiment of the present disclosure.

An embodiment of the present disclosure also provides a storage medium containing computer-executable instructions, wherein the computer-executable instructions, when executed by a computer processor, are used to execute the effect production method provided by the above embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1A is a flowchart of an effect production method provided by an embodiment of the present disclosure;

FIG. 1B shows an example diagram of an effect production interface in the effect production method provided by the present embodiment;

FIG. 1C shows another example diagram of an effect production interface in the effect production method provided by the present embodiment;

FIG. 1D shows an example diagram of an object material in the effect production method provided by the present embodiment;

FIG. 1E shows an example diagram of a content generated effect in the effect production method provided by the present embodiment;

FIG. 1F shows another example diagram of an effect production interface in the effect production method provided by the present embodiment;

FIG. 1G shows an example diagram of displaying a progress animation of effect generation in the effect production method provided by the present embodiment;

FIG. 2 is a schematic structural diagram of an effect production apparatus provided by an embodiment of the present disclosure; and

FIG. 3 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple apparatuses in the embodiments of the present disclosure are merely used for illustrative purposes, and are not used to limit the scope of these messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device.

It is to be understood that the preceding process of notifying the user and obtaining authorization from the user is illustrative only and does not limit the embodiments of the present disclosure, and that other manners complying with relevant laws and regulations may also be applied to the embodiments of the present disclosure. It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

It should be noted that in the prior art, the algorithms related to effect production are usually deployed on the server end, and then the effect creators input the original image, the generation description information related to the content generated effect and other parameter information through the network request based on the creation end, so as to obtain the final effect image. When the effect creators want to use the existing effect production method to create effect images, they must know how to set the generation description information and the generation parameter information in code form, and the setting of these information often requires the effect creators to have a certain programming foundation. Therefore, the entire procedure of the existing implementation of creating effect images is complicated, and it has a high creation difficulty, and its usability is poor, making it difficult to popularize among non-professional people.

The existing effect production methods cannot solve the above problems well. However, the method provided by the present embodiment does not require programming foundation for external users to achieve effect production, and the entire procedure of effect production is simple to operate, which improves the convenience of effect production and improves the user experience.

The embodiments of the present disclosure provide an effect production method and apparatus, a device and a storage medium. The method includes: displaying a created object on an effect production interface, and displaying an object production configuration panel triggered for the object; receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; invoking and running, after a production trigger condition of a content generated effect is satisfied, a resource package of the content generated resource, and performing content generation processing on the object to obtain the content generated effect. According to the technical solution in the present embodiment, a resource package is formed by using generation description information and generation parameter information, etc., required for the production of a content generated effect; after the resource package is formed, an object production configuration panel is presented on the interactive level by exposing parameters, so that the effect creators can adjust the content related to the effect, and the production of the content generated effect required by the effect creators can be realized. Through simple human-computer interaction, effect production can be achieved without code programming, which simplifies the operations of effect production, reduces the difficulty of effect production, improves the convenience and user experience of effect production, and can also derive a variety of gameplay effects at the same time.

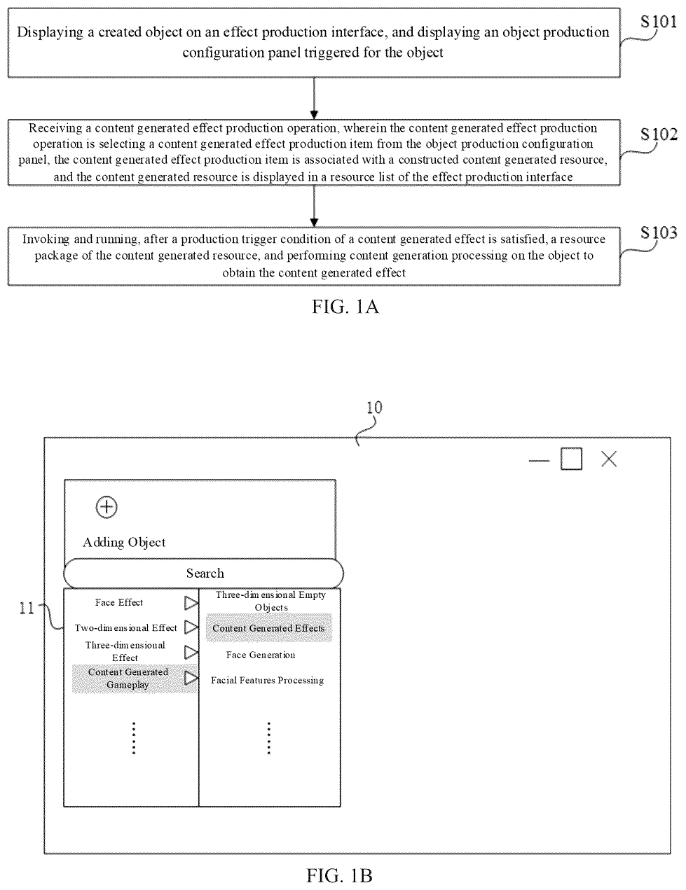

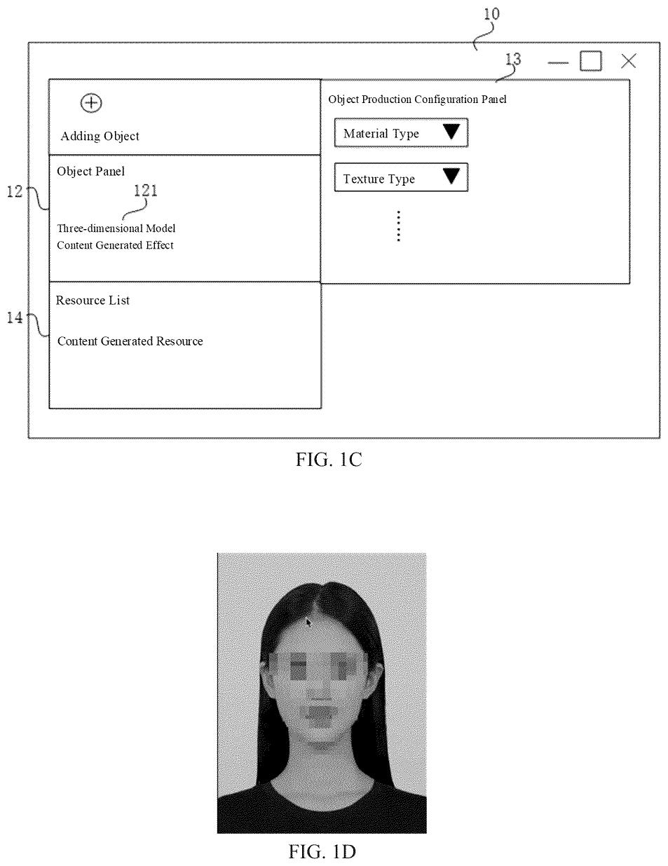

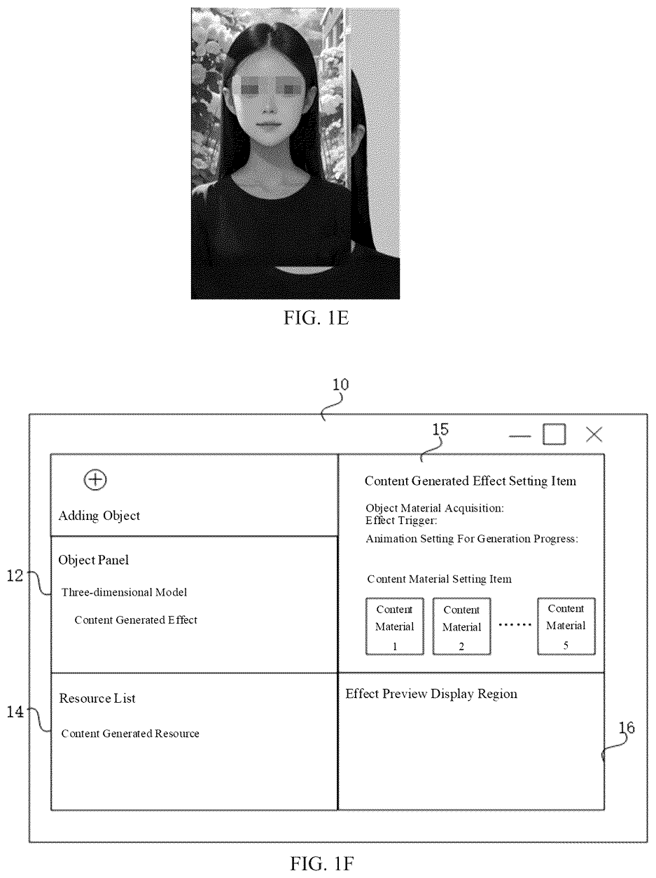

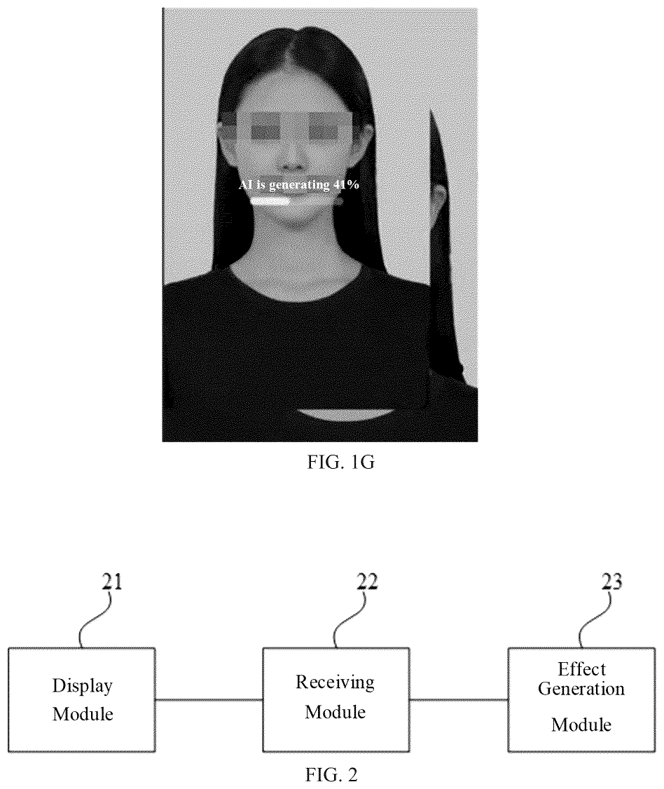

FIG. 1A is a flowchart of an effect production method provided by an embodiment of the present disclosure. The embodiment of the present disclosure is applicable to the case of producing effects. The method can be executed by an effect production apparatus. The apparatus can be implemented in the form of software and/or hardware, or alternatively, can be implemented by an electronic device as an execution terminal. The electronic device can be a mobile terminal, a PC terminal or a server, etc.

As shown in FIG. 1A, an effect production method provided by an embodiment of the present disclosure specifically includes:

S101: Displaying a created object on an effect production interface, and displaying an object production configuration panel triggered for the object.

The effect production method provided by the present embodiment can be integrated on an electronic device and presented to the effect creators in the form of an effect production tool for the effect creators to produce effects, and image effects required by the effect creators can be formed through the effect production tool. For example, the object includes an object to be produced. The object to be produced can be specifically understood as an object that needs to be produced. Different types of objects to be produced can be created according to different production requirements, for example, the objects to be produced can be two-dimensional images, three-dimensional models, and so on. Object types are diverse, and the effect creators can choose the object type they want to produce according to their own needs.

Considering the existing implementation of creating effect images, effect creators must know how to set generation description information and generation parameter information in code form, and the setting of these information often requires effect creators to have a certain programming foundation. In order to solve the above problems, in the present embodiment, the original image required for generating the content generated effect, the generation description information and the generation parameter information related to forming the content generated effect, or the like, are packaged to form a resource package. When effect production is triggered, by invoking the generated resource package and submitting it to the server end, the server end can generate the content generated effect according to the generation description information and the generation parameter information contained in the resource package and required for generating the content generated effect.

In the present embodiment, based on the formed resource package, the object material of the object to be produced is determined, and the content material image of what style is wanted to be added to the object to be produced is determined, and then the determined object material and the selected content material image can be uploaded to the server end through running of the resource package, and finally the image effect generated by the server end can be obtained. The image effect is equivalent to a content generated image formed by adding a selected style to the object material.

Following the above description, in the entire procedure of implementation, the effect creators can realize the effect production by only inputting the original image and some simple information configuration required for effect image production, and the effect creators can realize the image effect production without having a programming foundation.

In the present embodiment, an effect production interface can be presented after the effect production tool is started to run, wherein an adding object control is displayed in a display region of the effect production interface. When the effect creators want to produce effects, they can trigger to the adding object control, so that an object name list containing different object names is displayed in the effect production interface. Afterwards, the effect creators can select the effect object to be produced in the object name list according to the effect production requirements.

It should be noted that when the object name of the object to be produced is triggered from the object name list, it is equivalent to creating the object to be produced, and the object name of the created object to be produced can be displayed in the object panel of the effect production interface. The object panel can be used to display all of the created objects to be produced (which may be newly created effect objects or effects objects that have already been in the production procedure after being created).

In the present embodiment, when the object name of the object to be produced in the object panel is triggered, the object production configuration panel corresponding to the object to be produced will be displayed in a set region of the effect production interface. The object production configuration panel can be understood as a panel for configuring production requirements of the object to be produced, the object production configuration panel contains several configurable production configuration items which are used to configure the information related to the production requirements of the object to be produced, and the object production configuration panel includes effect selection configuration items for selecting effects to be added to the object to be produced.

Following the above description, the effect selection configuration items of the object production configuration panel include content generated effect production items formed based on the constructed content generated resource. If the effect creators want to add the effect of content generated effects to the object to be produced, they can select the content generated effect production items from a drop-down list of the effect selection configuration items of the object production configuration panel.

Illustratively, FIG. 1B shows an example diagram of an effect production interface in the effect production method provided by the present embodiment. As shown in FIG. 1B, when the adding object button is clicked, an object name list 11 will be displayed in a display region on the effect production interface 10. For example, the object name list 11 can include optional options of objects to be produced, such as face effect, two-dimensional effect, three-dimensional effect, content generated gameplay, etc. The content generated gameplay can further include optional options of objects to be produced, such as three-dimensional empty objects, content generated effects, face generation, facial features processing. These options of objects to be produced are presented through the set object names. When a certain object name is selected from the displayed object name list, an object to be produced corresponding to the object name will be created.

Meanwhile, FIG. 1C shows another example diagram of an effect production interface in the effect production method provided by the present embodiment. As shown in FIG. 1C, after clicking the adding object button to add an object to be produced and start the creation of the object to be produced, an object name 121 of the created object to be produced (e.g., content generated effect) will be displayed on the object panel 12 of the effect production interface 10. When the object name 121 of the object to be produced is triggered, an object production configuration panel 13 associated with the object to be produced will pop up on the effect production interface 10.

It can be known that there are many configuration items in the object production configuration panel. In addition to the effect selection configuration items for selecting the effects added to the object to be produced, the object production configuration panel can further include other configuration items required for setting the basic properties of this kind of objects to be produced and the configuration requirements involved in the development stage, such as a mixed mode configuration item, a stretch mode configuration item, a color configuration item, a transparency configuration item, a flip configuration items or advanced settings, etc.

Illustratively, assuming that the created object to be produced is a two-dimensional foreground, an object production configuration panel corresponding to a two-dimensional image is displayed. Assuming that the created object to be produced is a three-dimensional model, an object production configuration panel corresponding to the three-dimensional model is displayed. The configuration items included in the object production configuration panels corresponding to different objects to be produced are different.

S102: Receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface.

In the present embodiment, after the object is added, a content generated effect production operation can be selected from the object production configuration panel which is triggered to be displayed. The object production configuration panel contains all attribute types that can be produced on the object to be produced, such as texture type and material type, and each attribute type can correspond to an effect selection configuration item. In the present embodiment, the content generated resource can be constructed according to the corresponding attribute characteristics under different attribute types, so that the content generated effect production items with the corresponding attribute types can be formed and included in effect selection configuration items corresponding to different attribute types.

Illustratively, assuming that the created object to be produced is a two-dimensional foreground, the attribute types that can be produced for the two-dimensional foreground include texture type; and in this case, the content generated effect production item can be used as a producible effect selection item under the texture type. Assuming that the created object to be produced is a three-dimensional model, the attribute types that can be produced for the three-dimensional model include texture type and material type, etc.; and in this case, the content generated effect production item can be used as a producible effect selection item under the texture type, and can also be used as a producible effect selection item under the material type.

Following the above description, when the effect creators select the content generated effect production item under the texture type from the object production configuration panel, the produced content generated effect can be regarded as the texture effect of the object to be produced. Similarly, when the effect creators select the content generated effect production item under the material type from the object production configuration panel, the produced content generated effect can be regarded as the material effect of the object to be produced.

In the present embodiment, the resource package of the content generated resource can be constructed in the development stage. Illustratively, the construction steps of the content generated resource include: firstly, acquiring script content required for logic execution of the content generated effect. The key to packaging the content generated effect lies in packaging the execution logic content involved in the content generated effect. This step can acquire the script content required for the logic execution of the content generated effect. Then, according to the acquired construction configuration information, a resource framework with a set resource format is constructed. This step can acquire the construction configuration information, and can realize the construction of a resource framework with a set resource format according to the construction configuration information. Finally, the script content is filled into the resource framework, and the resource framework filled with the script content is packaged into a resource package to form the content generated resource of the content generated effect. Through the execution of the above steps, the content generated effect can be integrated into the effect production tool in the form of resource, so that the effect creators can introduce the effect function of the content generated effect into the produced object by invoking the content generated resource when producing effects, thus realizing the production of different effects.

In the present embodiment, by constructing content generated resources of different production types, the content generated effect production items can be selected under effect production items of different production types according to different production requirements. When producing effects, this effect can be added as an effect of the texture type, and can also be produced as an effect of the material type. These texture types and material types can be regarded as effect-related production items and recorded as content generated effect production items. Understandably, it provides a production approach for secondary referencing to specific effects on the level of effect production, and at the same time, it also expands the application scope of specific effects, thus greatly improving the gameplay form of the produced effects in the application scenarios and improving the gameplay experience of effects.

Different from the existing effect production that requires the effect creators to write their own codes to set the generation description information and generation parameter information, etc., in the present embodiment, the code logic is integrated into the resource package, and the resource package exposes some parameter interfaces to the external, so that the effect creators can set or select these parameters. Based on these simple operations, the setting of the generation description information and the generation parameter information, etc., related to the content generated effect can be realized. Each content generated effect production item is associated with a constructed content generated resource, and the content generated resources can be displayed in the effect production interface in the form of a list. In the present embodiment, the complex process of network algorithm request is packaged at the bottom layer, which is not exposed to external users, and some self-defined attributes are displayed, thus making it more convenient for effect creators to produce effects.

S103: Invoking and running, after a production trigger condition of a content generated effect is satisfied, a resource package of the content generated resource, and performing content generation processing on the object to obtain the content generated effect.

In the present embodiment, the resource package of the content generated resource can be specifically understood as a resource package integrated with the code logic of the content generated resource. Different from the existing effect production that requires the effect creators to write their own codes to set the generation description information and generation parameter information, etc., in the present embodiment, the code logic are integrated into the resource package, and the resource package exposes some parameter interfaces to the external, so that the effect creators can set or select these parameters. Based on these simple operations, the setting of the generation description information and the generation parameter information, etc., related to the content generated effect can be realized

The content generated effect of the object to be produced can be specifically understood as the final effect obtained after rendering the object to be produced. It should be noted that the determination of the generation parameter information required for generating the content generated effect is performed by the execution subject, and the parameter information will be uploaded to the server end, and the server end will perform the generation of the content generated effect.

In order to clarify the content generation processing on the object to be produced based on the effect production method provided by the present embodiment and obtaining the effect of content generated effects, a certain person image is taken as an example for description. Illustratively, FIG. 1D shows an example diagram of an object material in the effect production method provided by the present embodiment. As shown in FIG. 1D, the effect creators can select a certain person image as the object material of the object to be produced to participate in the subsequent content generated effect production. FIG. 1E shows an example diagram of a content generated effect in the effect production method provided by the present embodiment. As shown in FIG. 1E, based on the effect production method provided by the present embodiment, the content generated effect production can be performed on the person image in FIG. 1D with the content generation style of “realism style”, and after completion of the production, the object material can present the content generated effect as shown in FIG. 1E.

In the present embodiment, the execution subject will detect a received execution event, and the received execution event can be understood as an event executed by the effect creators. When it is detected that the received execution event is a pre-configured production trigger event, it can be considered that the production trigger condition of the content generated effect is satisfied, and the resource package of the content generated resource will be invoked.

Specifically, through the running of the resource package, firstly, it is determined which effect of content generation is selected by the effect creators, and an object material to be rendered and introduced for the object to be produced is received. The information can be generated by selecting the content generation and importing the object material after the content generated effect production item is selected. It is equivalent to determining what style of content material information is used to render and receiving which object material is to be rendered based on the selected content material information.

Based on the above description, after the information related to rendering is determined, the specific rendering procedure is executed on the server end, and the execution subject needs to upload the information related to rendering to the server end, so that the content generated effect of the object to be produced can be formed through the server end based on the target content material and the object material. It can be considered that the service platform is composed of multiple server ends, and different server ends correspond to different content generation effects. When the object material of the object to be produced is processed in a certain generation style to form the content generation effect, it is necessary to find the server end corresponding to the generation style processing. The target content material and the object material involved in content generation are uploaded to the corresponding server end, and the content generated effect of the object to be produced is formed based on the target content material and the object material through the server end.

It can be known that for the implementation of the content generation processing on the server end, the content generation that matches the content generation style can be achieved through a deep neural network model on the server end. Different server ends can be configured with deep neural network models that match different content generation styles, the server end can input the received target content material and object material as input information to the deep neural network model, the content generation logic can be executed through the deep neural network model, and the information output by the deep neural network model can be used as the content generated effect matching the style of the target content material.

Following the above description, the deep neural network models can be pre-trained by using sample materials with a certain content generation style. Therefore, when the deep neural network models are respectively trained by using sample materials with different content generation styles, the deep neural network models matching these content generation styles can be obtained for forming content generated effects.

In the effect production method provided by the present embodiment, a resource package is formed by using generation description information and generation parameter information, etc., required for the production of a content generated effect; after the resource package is formed, an object production configuration panel is presented on the interactive level by exposing parameters, so that the effect creators can adjust the content related to the effect, and the production of the content generated effect required by the effect creators can be realized. Through simple human-computer interaction, effect production can be achieved without code programming, which simplifies the operations of effect production, reduces the difficulty of effect production, improves the convenience and user experience of effect production, and can also derive a variety of gameplay effects at the same time.

As a first alternative embodiment of the present embodiment, on the basis of the above embodiment, the method can be further optimized and further includes:
a1) Displaying, in response to a resource configuration operation, a resource parameter configuration panel, wherein the resource configuration operation is selecting the content generated resource in the resource list.

In this embodiment, on the basis of the generation procedure of the content generated effect mentioned above, an approach to realize personalized configuration can be further provided through the configuration of the content generated resource. Content generated resources are displayed in the resource list of the effect production interface. When personalized configuration is needed for the generation of the content generated effect, the content generated resource in the resource list can be selected. In this embodiment, the operation of selecting the content generated resource in the resource list is referred to as a resource configuration operation. In response to the resource configuration operation, the execution subject will parse the resource configuration operation, so as to determine which content generated resource is selected from the resource list for the resource configuration operation, and obtain which setting items correspond to the content generated resource, thus displaying the resource parameter configuration panel. The resource parameter configuration panel contains several setting items for personalized parameter setting of image effect generation, and the effect creators can set the setting items in the resource parameter configuration panel according to the requirements of effect production.

In this embodiment, which setting items are specifically included in the resource parameter configuration panel can be set according to actual needs in the development stage, and there is no specific restriction on which setting items are specifically included. Illustratively, the setting items in the resource parameter configuration panel can include a content generated effect setting item and a content material setting item. The content generated effect setting item can include an object material acquisition setting item, an effect trigger setting item and an animation setting item for generation progress. The content material setting item can include at least one candidate content material required for generating the content generated effect. In addition to the setting items listed above, also included can be a setting item for whether to check the default transition effect, a setting item of a dwell duration after generation, a setting item of image keywords, a setting item of keyword strength, etc., and advanced editing can also be carried out according to actual needs, without specific restrictions here.

It can be known that there can be many produced types of content generated effects. For example, if the content generated effect is constructed as a content generated effect production item of a material type, it can be used to produce a material effect, that is, the material type corresponds to a resource package of the content generated resource of this type; if the content generated effect is constructed as a content generated effect production item of a texture type, it can be used to produce a texture effect, that is, the texture type also corresponds to a resource package of the content generated resource of another type. It should also be noted that when the content generated effect production item under the texture type is selected, the content generated resources corresponding to the texture type can be displayed in the resource list of the effect production interface. Similarly, when the content generated effect production item under the material type is selected, the content generated resources corresponding to the material type will be displayed in the resource list of the effect production interface. It can be considered that the resource packages of content generated resources under different types are different and independent of each other. When both the content generated effect production item under the texture type and the content generated effect production item under the material type are selected, content generated resources of both types will be displayed in the resource list and independent of each other. It is equivalent that if a resource package of a certain type is selected, then content generated resources of this type will be displayed in the resource list. When a resource package of a corresponding type is pre-constructed, the content generated effect production item of the corresponding type can be selected.

With continued reference to FIG. 1C, the content generated effect production item can be selected from the drop-down options corresponding to the material type in the object production configuration panel 13, or the content generated effect production item can be selected from the drop-down options of the texture type in the object production configuration panel 13; and after the content generated effect production item is selected, the content generated resources associated with the content generated effect production item will be displayed in the resource list 14. It should be noted that in practical applications, the content generated resources of the selected content generated effect production item will be independently presented in the resource list according to the attribute types of the object to be produced (the descriptive effect is not presented in FIG. 1C), and after the content generated resources presented under different attribute types are selected, respective resource parameter configuration panels will be presented separately.
b1) Receiving parameter configuration information formed after a setting item in the resource parameter configuration panel is set.

Different from the existing effect production that the generation description information and the generation parameter information need to be set in the form of code writing, in this embodiment, the effect creators do not need to write codes for relevant information, while some human-computer interaction interfaces are provided in the form of resource parameter configuration panel; and the effect creators can realize the effect production by simply setting the setting items in the resource parameter configuration panel instead of the existing code writing.

In this embodiment, when the effect creators want to personalize the effect production, they can set the setting items in the resource parameter configuration panel; and then the execution subject receives the setting operations on the setting items in the resource parameter configuration panel and parse what parameter information each setting item is set to, so as to receive the parameter information formed after the setting items in the resource parameter configuration panel are set, and record these parameter information as parameter configuration information.

Preferably, the setting item in the resource parameter configuration panel includes a content generated effect setting item and a content material setting item; the content generated effect setting item includes an object material acquisition setting item, an effect trigger setting item and an animation setting item for generation progress; the content material setting item includes at least one candidate content material required for producing the content generated effect, and generation description information associated with the at least one candidate content material is pre-packaged in the resource package.

The object material acquisition setting item is used to assign a specific content to the object to be produced, that is, to set the source of the material to be used for effects production. The parameter information of the object material acquisition setting item can be an image uploaded by a user or an image captured in real time by a camera, etc., and the image is taken as an object material to be processed. The effect trigger setting item can be specifically understood as a setting item of a trigger mode for executing effect production, and the parameter information of the effect trigger setting item can be triggering by clicking on the screen, triggering after uploading an image, or triggering through a shortcut key, etc. The animation setting item for generation progress can be specifically understood as a setting item about how to show the progress of effect generation. The content material setting item can be specifically understood as a setting item for setting the candidate content material required for generating the content generated effect, and the candidate content material can be specifically understood as what kind of effect is to be generated for the image; for example, the candidate content material can include “realism style”, felt-style pet style, Monet style, clay style, etc. One candidate content material corresponds to one effect. Based on the candidate content material, the image to be processed can be rendered in a content generation style. The effect creators set the setting items in the resource parameter configuration panel according to their own needs.

FIG. 1F shows another example diagram of an effect production interface in the effect production method provided by the present embodiment. As shown in FIG. 1F, when the effect creators select a content generated resource in the resource list 14, a corresponding resource parameter configuration panel 15 will be displayed, and the resource parameter configuration panel 15 includes a content generated effect setting item and a content material setting item; the content generated effect setting item includes an object material acquisition setting item, an effect trigger setting item and an animation setting item for generation progress; the content material setting item includes a first candidate content material 1, a second candidate content material 2 and more candidate content materials, such as a fifth candidate content material 5 or the like, which are required for generating the content generated effect.

It should be known that when setting different setting items in the resource parameter configuration panel, each setting item may be set in different ways. Some setting items can be set by checking, some setting items need to be set by sliding, and some setting items can be set by filling in. For example, when setting the object material acquisition setting item, it can be set by clicking to select or the like. For the effect trigger setting item, it can be set by drop-down check. For the dwell duration after generation, the dwell duration can be set by sliding a progress bar. In this embodiment, default parameter information can also be set for each setting item in the resource parameter configuration panel.

Illustratively, assume that the effect creators upload an original image as the object material, sets “clicking on the screen” as the trigger mode of effect generation in the effect trigger setting item, selects the expected animation of the generation procedure, and selects the candidate content material with a content generation style of “realism style”, the generation description information, such as “in the garden, green plants, soft light on the face”, etc., is automatically filled in the image keywords, and the execution subject will receive the parameter configuration information formed by these settings.

In the above-mentioned technical solution of the first alternative embodiment, different from the prior art in the generation description information and the generation parameter information need to be set in the form of code writing, this technical solution is embodied in the form of resource parameter configuration panel, and the effect creators can realize the effect production by simply setting the setting items in the resource parameter configuration panel instead of the code writing in the existing effect production, thus simplifying the procedure of effect production, increasing the personalized configuration of the content generated effect production through content generated resource configuration, providing a foundation for the diversity of content generated effects, and satisfying the personalized needs of users.

As a second alternative embodiment of this embodiment, after a production trigger condition of a content generated effect is satisfied, the specific implementation of invoking and running a resource package of the content generated resource, and performing content generation processing on the object to be produced to obtain the content generated effect, can be further optimized as the following steps:
a2) Invoking, when it is detected that a received execution event is a pre-configured production trigger event, the resource package of the content generated resource.

Acquisition approaches of the production trigger event, the target content material and the object material are all included in parameter configuration information formed by configuring the content generated resource.

In this embodiment, after the effect creators finishes setting the setting items in the resource parameter configuration panel, parameter configuration information related to the setting will be formed. The execution subject will detect a received execution event, and the received execution event can be understood as an event executed by the effect creators. Because the execution subject will receive the parameter configuration information formed by pre-configuration, the parameter configuration information includes the configuration of the effect trigger setting item, that is, includes the production trigger event for triggering the effect production. When it is detected that the received execution event is a pre-configured production trigger event, it can be considered that the production trigger condition of the content generated effect is satisfied, and the resource package of the content generated resource will be invoked. Illustratively, assuming that the effect trigger setting item is configured as triggering by clicking on the screen, when the effect creators click on the screen, the execution subject detects that the received execution event is a pre-configured event of triggering by clicking on the screen, and will invoke the resource package of the content generated resource.
b2) Determining, through running of the resource package, a selected target content material and receiving an object material introduced for the object to be produced.

In this embodiment, two steps, b2) and c2), are executed through the running of the resource package. Specifically, through the running of the resource package, it will be firstly determined which target content material is selected, and the object material introduced for the object to be produced is received. Because the execution subject will receive the parameter configuration information formed by pre-configuration, the parameter configuration information includes the configuration of the object material acquisition setting item, that is, includes the object material to be rendered and introduced for the object to be produced. Similarly, the parameter configuration information further includes information about the setting of the content material setting item, that is, the parameter configuration information includes content material information for content generation rendering of the object material, and the content material information can be recorded as the target content material.

This step is equivalent to determining what kind of content generation style is used to render, and receiving which object material is to be rendered based on the target content material. Illustratively, assuming that the effect creators upload the original person image and selects the candidate content material of the realism style when setting the setting items in the resource parameter configuration panel, the original person image is the object material for the object to be produced, and the candidate content material of the realism style is the target content material.
c2) Uploading the target content material and the object material to a server end corresponding to the target content material, so as to form the content generated effect of the object to be produced through the server based on the target content material and the object material.

In this embodiment, one content generated effect corresponds to a server with one content generation style, and different content generated effects have different server ends participating in the processing when they have different content generation styles. When the target content material is processed to generate the content generated effect, it needs to find the server end corresponding to the target content material. It can be considered that the service platform is composed of multiple server ends, and different server ends correspond to different content generation styles. Illustratively, when the selected target content material has a content generation style of clay style, it can correspond to one server end, and when the selected target content material has a content generation style of realism style, it can correspond to another server end. In order to generate a content generated effect of the content generation style corresponding to the target content material, it needs to upload the target content material and the object material to the server end corresponding to the target content material, so as to form the content generated effect of the object to be produced based on the target content material and the object material through the server end.

The above-mentioned technical solution of the second alternative embodiment specifically illustrates the step of generating the content generated effect of the object to be produced. By invoking the resource package of the content generated resource, the target content material and the object material are determined and uploaded to the corresponding server end, so as to form the content generated effect of the object to be produced through the server end based on the target content material and the object material. The information required for the production of the content generated effect is formed into a resource package, and the generation of the content generated effect can be realized through the invoking of the resource package. Based on simple human-computer interaction, effect production can be implemented without programming. It simplifies the entire procedure of effect production and improves the user experience.

As a third alternative embodiment of the present embodiment, in the procedure of effect production, some animation displays can also be used to illustrate the effect generation procedure, which can specifically include:
a3) Displaying an object material serving as the object to be produced in an effect preview display region, and displaying a progress animation of effect generation on the object material, wherein animation style information of the progress animation is included in parameter configuration information formed by configuring the content generated resource.

It should be known that because the execution subject will receive the parameter configuration information formed by pre-configuration, the parameter configuration information includes the configuration of the animation setting item for generation progress, that is, includes the animation style information used to characterize the progress animation. In this embodiment, in the effect generation procedure, the object material of the object to be produced can be displayed in the effect preview display region, and the progress animation of effect generation can be displayed on the object material, and the progress animation is displayed based on the animation style information in the parameter configuration information. With continued reference to FIG. 1F, the effect production interface 10 includes an effect preview display area 16, which is used for displaying the object material and displaying the progress animation of effect generation on the object material.

Illustratively, FIG. 1G shows an example diagram of displaying a progress animation of effect generation in the effect production method provided by the present embodiment. As shown in FIG. 1G, in the procedure of effect production, a person image is displayed as the object material of the object to be produced in the effect preview display region, and the progress animation of effect generation is shown in the form of a progress bar and percentage, so that the effect creators can feel the procedure of effect production more directly.
b3) Displaying, after a display condition of the content generated effect is satisfied, a generation animation from the object material to the content generated effect in the effect preview display region.

In this embodiment, if the generated content generated effect is received within a set time after the resource package is started to run, it is considered that the display condition of the content generated effect is satisfied. Considering that if the original object material is directly replaced by the generated content generated effect, the presented visual effect is relatively stiff; in this embodiment, the transformation process from the object material to the content generated effect is displayed in the form of generation animation, so as to ensure that it has a better visual effect. Specifically, after the display condition of the content generated effect is satisfied, in the effect preview display region, a generation animation will be formed based on the object material and the content generated effect returned by the server end, thus displaying the generation animation from the object material to the content generated effect.

As a specific implementation, the step of displaying, after a display condition of the content generated effect is satisfied, a generation animation from the object material to the content generated effect in the effect preview display region, can be optimized, which includes:
b31) Determining, when a generated content generated effect is received within a set time after the resource package is started to run, that the display condition of the content generated effect is satisfied.

In this embodiment, the processing results of the server end are continuously monitored to judge whether the generated content generated effect is received within the set time after the resource package is started to run. If the generated content generated effect is received within the set time, it is determined that the display condition of the content generated effect is satisfied.
b32) Determining a content fading region in the object material, and filling the content fading region with content of the content generated effect while fading content in the content fading region.

In this embodiment, the content generated effect can be displayed after the display condition of the content generated effect is satisfied. Generally, the displayed object material can be directly replaced by the content generated effect. However, in order to display a better visual effect, this embodiment can form a transition display animation by displaying from the object material to the content generated effects. In this embodiment, the transition display animation from the object material to the content generated effect can be realized through this step and the following step b33).

Specifically, in this embodiment, the image content of the object material can be continuously dissolved, and in the procedure of dissolution, the animation effect of using the image content of the content generated effect to replace the dissolved region forms the transition display animation. The content fading region can be understood as a content conversion region which is used to reflect the content dissolution of the object material and the content filling of the content generated effect in the procedure of replacing the object material with the content generated effect.

In this embodiment, a content fading region with a regular pattern such as a circle or rectangle, etc., can be selected from the center of the object material, and the content fading region continuously expands outward; the content of the object material contained in the content fading region will be continuously faded, and when it is faded to a certain extent, the content of the object material will be replaced by the content of the content generated effect, until the entire content of the object material is gradually replaced and filled by the content of the content generated effect.

For animation displayed in the above form, because the content fading region gradually expands in a regular pattern, the content conversion effect presented by the animation is relatively rigid and the visibility is not very good. Based on this, this embodiment can randomly determine the content fade region in the object material in the form of some noise, and then replace the content of the object material with the content of the content generated effect in the procedure of gradually fading the content of the object material in the content fading region, so as to form the animation effect of randomly replacing the content of the object material with the content generated effect. This method uses randomness when fading, and the animation effect presented is equivalent to slowly dissolving the object material through irregular patterns, and then the content generated effect is displayed. It is ensured that the generation animation has a good presentation effect.
b33) Returning to re-execute the operations of determining content fade area, content fading and filling until the whole object material is filled with the content generated effect.

In this embodiment, the operations of determining content fading region, content fading and filling are repeatedly performed, until the whole object material is filled with the content generated effect.

The above technical solution specifically illustrates the step of displaying a generation animation from the object material to the content generated effect in the effect preview display region. Randomness is adopted during fading, so that the effect presented by the animation is to slowly dissolve the object material through irregular patterns, and then the content generated effect is displayed, thus ensuring that the generation animation has a good presentation effect.
c3) Displaying, when it is determined that the display condition of the content generated effect is not satisfied, a prompt for failed effect generation in the effect preview display region.

In this embodiment, if the generated content generated effect is not received within a set time after the resource package is started to run, it is considered that the display condition of the content generated effect is not satisfied. When it is determined that the display condition of the content generated effect is not satisfied, a prompt for failed effect generation is displayed in the effect preview display region.

The above-mentioned technical solution of the third alternative embodiment adds the function of animation display in the procedure of effect production, which improves the user experience.

As a fourth alternative embodiment of the present embodiment, on the basis of the above embodiments, the construction steps of the content generated resource can be further optimized to include:
a4) Acquiring script content required for logic execution of the content generated effect.

In this embodiment, the key to packaging the content generated effect lies in packaging the execution logic content involved in the content generated effect. This step can acquire the script content required for the logic execution of the content generated effect, wherein the script content can be considered as containing the logic code related to the content generated effect.
b4) Constructing a resource framework with a set resource format according to acquired construction configuration information.

In this embodiment, this step can acquire the construction configuration information, and can realize the construction of a resource framework with a set resource format according to the construction configuration information. The construction configuration information can be understood as a configuration file or operation setting information used for resource framework construction, and the construction configuration information can be formed after the designer carries out the framework construction configuration operation and be obtained through this step.

Illustratively, the frame construction configuration operation being performed can be to embed the plug-in code required by the resource frame construction in the effects production tool, import the configuration file and set the resource format of the resource frame, etc., wherein the resource format of the resource frame can be set as a code format type that can inherit the existing map component code in the effect production tool, such as the resource frame JsAsset composed of JS programming language.

This step can implement the construction of the resource framework according to the given construction logic after obtaining the construction configuration information and the set resource format of the resource to be constructed. And it can be known that this step can construct a resource framework with empty content.
c4) Filling the script content into the resource framework, and packaging the resource framework filled with the script content into a resource package to form the content generated resource of the content generated effect.

In this embodiment, through the execution of this step, the script content related to the content generated effect can be added to the above-mentioned constructed resource framework, so that the resource framework can have the logical execution ability to execute the content generated effect. In this step, after it is detected that the filling of the script content is completed, the summary of various related files/contents involved in the resource framework can be carried out, so as to package the related files/contents into a resource package of the content generated effect, which is recorded as the content generated resource of the content generated effect in this embodiment.

It should be noted that in the construction stage of the content generated resource, the tag type of the constructed content generated resource can also be set; for example, the tag type of the content generated resource can be set to the map type. In addition, the configuration of function invoking can be carried out for the content generated resource. By setting it as the main function object, the resource package of the content generated resource can be effectively invoked after the attribute configuration item with the content generated resource is selected in the effect production stage.

Through the execution of the above technical solution in this embodiment, the content generated effect can be integrated into the effect production tool in the form of resource, so that the effect creators can introduce the effect function of the content generated effect into the produced object by invoking the content generated resource when producing effects, thus realizing the production of different effects, and further, expanding the application scope of effects and achieving the effect of enriching the effect gameplay forms.

FIG. 2 is a schematic structural diagram of an effect production apparatus provided by an embodiment of the present disclosure. As shown in FIG. 2, the apparatus includes a display module 21, a receiving module 22 and an effect generation module 23.

The display module 21 is configured to display a created object on an effect production interface, and display an object production configuration panel triggered for the object;
the receiving module 22 is configured to receive a content generated effect production operation, wherein the content generated effect production operation is selecting a content generated effect production item from the object production configuration panel, the content generated effect production item is associated with a constructed content generated resource, and the content generated resource is displayed in a resource list of the effect production interface;
the effect generation module 23 is configured to invoke and run, after a production trigger condition of a content generated effect is satisfied, a resource package of the content generated resource, and perform content generation processing on the object to obtain the content generated effect.

According to the technical solution provided by the embodiment of the present disclosure, a resource package is formed by using generation description information and generation parameter information, etc., required for the production of a content generated effect; after the resource package is formed, an object production configuration panel is presented on the interactive level by exposing parameters, so that the effect creators can adjust the content related to the effect, and the production of the content generated effect required by the effect creators can be realized. Through simple human-computer interaction, effect production can be achieved without code programming, which simplifies the operations of effect production, reduces the difficulty of effect production, improves the convenience and user experience of effect production, and can also derive a variety of gameplay effects at the same time.

Further, the apparatus further includes a configuration module, which is specifically configured to:
display, in response to a resource configuration operation, a resource parameter configuration panel, wherein the resource configuration operation is selecting the content generated resource in the resource list;
receive parameter configuration information formed after a setting item in the resource parameter configuration panel is set.

Further, the setting item in the resource parameter configuration panel includes a content generated effect setting item and a content material setting item;
the content generated effect setting item includes an object material acquisition setting item, an effect trigger setting item and an animation setting item for generation progress;
the content material setting item includes at least one candidate content material required for producing the content generated effect, and generation description information associated with the at least one candidate content material is pre-packaged in the resource package.

Further, the effect generation module 23 is specifically configured to:
invoke, when it is detected that a received execution event is a pre-configured production trigger event, the resource package of the content generated resource;
determine, through running of the resource package, a selected target content material and receive an object material introduced for the object;
upload the target content material and the object material to a server end corresponding to the target content material, so as to form the content generated effect of the object through the server based on the target content material and the object material;
wherein acquisition approaches of the production trigger event, the target content material and the object material are all included in parameter configuration information formed by configuring the content generated resource.

Further, the apparatus further includes an animation prompt module, wherein the animation prompt module includes:
a progress display unit, configured to display an object material serving as the object in an effect preview display region, and display a progress animation of effect generation on the object material, wherein animation style information of the progress animation is included in parameter configuration information formed by configuring the content generated resource;
an animation display unit, configured to display, after a display condition of the content generated effect is satisfied, a generation animation from the object material to the content generated effect in the effect preview display region;
an error prompt unit, configured to display, when it is determined that the display condition of the content generated effect is not satisfied, a prompt for failed effect generation in the effect preview display region.

Further, the animation display unit is specifically configured to:
determine, when a generated content generated effect is received within a set time after the resource package is started to run, that the display condition of the content generated effect is satisfied;
determine a content fading region in the object material, and fill the content fading region with content of the content generated effect while fading content in the content fading region;
return to re-execute the operations of determining content fading region, content fading and filling until the whole object material is filled with the content generated effect.

Further, the apparatus further includes a resource construction module, which is specifically configured to:
acquire script content required for logic execution of the content generated effect;
construct a resource framework with a set resource format according to acquired construction configuration information;
fill the script content into the resource framework, and package the resource framework filled with the script content into a resource package to form the content generated resource of the content generated effect.

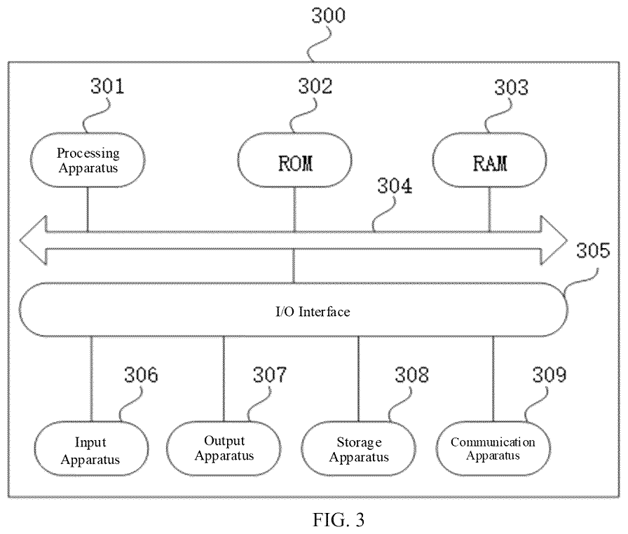

FIG. 3 is a schematic structural diagram of an electronic device provided by an embodiment of the present disclosure. Hereinafter, referring to FIG. 3, it shows a schematic structural diagram of an electronic device 300 (e.g., a terminal device or a server in FIG. 3) suitable for implementing the embodiment of the present disclosure. The terminal device in the embodiment of the present disclosure can include, but is not limited to, a mobile terminal such as a mobile phone, a laptop computer, a digital broadcast receiver, a personal digital assistant (PDA), a portable android device (PAD), a portable media player (PMP), a vehicle-mounted terminal (e.g., vehicle-mounted navigation terminal), etc., and a fixed terminal such as a digital television (TV), a desktop computer, etc. The electronic device shown in FIG. 3 is merely an example, and should not bring any limitation to the function and application scope of the embodiment of the present disclosure.

As shown in FIG. 3, the electronic device 300 may include a processing apparatus (such as a central processing unit, and a graphics processor) 301, it may execute various appropriate actions and processes according to a program stored in a read-only memory (ROM) 302 or a program loaded from a storage apparatus 308 to a random access memory (RAM) 303. In RAM 303, various programs and data required for operations of the electronic device 300 are also stored. The processing apparatus 301, ROM 302, and RAM 303 are connected to each other by a bus 304. An input/output (I/O) interface 305 is also connected to the bus 304.

Typically, the following apparatuses may be connected to the I/O interface 305: an input apparatus 306 such as a touch screen, a touchpad, a keyboard, a mouse, a camera, a microphone, an accelerometer, and a gyroscope; an output apparatus 307 such as a liquid crystal display (LCD), a loudspeaker, and a vibrator; a storage apparatus 308 such as a magnetic tape, and a hard disk drive; and a communication apparatus 309. The communication apparatus 309 may allow the electronic device 300 to wireless-communicate or wire-communicate with other devices so as to exchange data. Although FIG. 3 shows the electronic device 300 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 309, or installed from the storage apparatus 308, or installed from ROM 302. When the computer program is executed by the processing apparatus 301, the above functions defined in the embodiments of the present disclosure are executed.

Names of messages or information exchanged among multiple apparatuses in the embodiments of the present disclosure are merely used for illustrative purposes, and are not used to limit the scope of these messages or information.

The electronic device provided by the embodiment of the present disclosure belongs to the same inventive concept as the effect production method provided by the above embodiment, and the technical details not provided in this embodiment can be found in the above embodiment, and this embodiment has the same beneficial effects as the above embodiment.

An embodiment of the present disclosure further provides a computer-readable storage medium, on which a computer program is stored; when the computer program is executed by a processor, the effect production method provided by the above embodiment is implemented.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-described computer-readable medium may be included in the above-described electronic device; or may also exist alone without being assembled into the electronic device.

The computer-readable medium carries one or more programs that, when executed by the electronic device, cause the electronic device to: display a created object on an effect production interface, and display an object production configuration panel triggered for the object; receive a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; invoke and run, after a production trigger condition of a content generated effect is satisfied, a resource package of the content generated resource, and perform content generation processing on the object to obtain the content generated effect.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, [Example 1] provides an effect production method, which includes: displaying a created object on an effect production interface, and displaying an object production configuration panel triggered for the object; receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; invoking and running, after a production trigger condition of a content generated effect is satisfied, a resource package of the content generated resource, and performing content generation processing on the object to obtain the content generated effect.

According to one or more embodiments of the present disclosure, [Example 2] provides an effect production method, which is optimized to further include: displaying, in response to a resource configuration operation, a resource parameter configuration panel, wherein the resource configuration operation is selecting the content generated resource in the resource list; receiving parameter configuration information formed after a setting item in the resource parameter configuration panel is set.

According to one or more embodiments of the present disclosure, [Example 3] provides an effect production method, which is further optimized that the setting item in the resource parameter configuration panel includes a content generated effect setting item and a content material setting item; the content generated effect setting item includes an object material acquisition setting item, an effect trigger setting item and an animation setting item for generation progress; the content material setting item includes at least one candidate content material required for producing the content generated effect, and generation description information associated with the at least one candidate content material is pre-packaged in the resource package.

According to one or more embodiments of the present disclosure, [Example 4] provides an effect production method, which is optimized that after a production trigger condition of a content generated effect is satisfied, the invoking and running a resource package of the content generated resource, and performing content generation processing on the object to obtain the content generated effect, includes: invoking, when it is detected that a received execution event is a pre-configured production trigger event, the resource package of the content generated resource; determining, through running of the resource package, a selected target content material and receiving an object material introduced for the object; uploading the target content material and the object material to a server end corresponding to the target content material, so as to form the content generated effect of the object through the server based on the target content material and the object material; wherein acquisition approaches of the production trigger event, the target content material and the object material are all included in parameter configuration information formed by configuring the content generated resource.

According to one or more embodiments of the present disclosure, [Example 5] provides an effect production method, which is optimized to further include: displaying an object material serving as the object in an effect preview display region, and displaying a progress animation of effect generation on the object material, wherein animation style information of the progress animation is included in parameter configuration information formed by configuring the content generated resource; displaying, after a display condition of the content generated effect is satisfied, a generation animation from the object material to the content generated effect in the effect preview display region; displaying, when it is determined that the display condition of the content generated effect is not satisfied, a prompt for failed effect generation in the effect preview display region.

According to one or more embodiments of the present disclosure, [Example 6] provides an effect production method, which is optimized that the displaying, after a display condition of the content generated effect is satisfied, a generation animation from the object material to the content generated effect in the effect preview display region, includes: determining, when a generated content generated effect is received within a set time after the resource package is started to run, that the display condition of the content generated effect is satisfied; determining a content fading region in the object material, and filling the content fading region with content of the content generated effect while fading content in the content fading region; returning to re-execute the operations of determining content fading region, content fading and filling until the whole object material is filled with the content generated effect.

According to one or more embodiments of the present disclosure, [Example 7] provides an effect production method, which is optimized that construction steps of the content generated resource includes: acquiring script content required for logic execution of the content generated effect; constructing a resource framework with a set resource format according to acquired construction configuration information; filling the script content into the resource framework, and packaging the resource framework filled with the script content into a resource package to form the content generated resource of the content generated effect.

According to one or more embodiments of the present disclosure, [Example 8] provides an effect production apparatus, which includes: a display module, configured to display a created object on an effect production interface, and display an object production configuration panel triggered for the object; a receiving module, configured to receive a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; an effect generation module, configured to invoke and run, after a production trigger condition of a content generated effect is satisfied, a resource package of the content generated resource, and perform content generation processing on the object to obtain the content generated effect.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect production method, comprising:
displaying a created object on an effect production interface, and displaying an object production configuration panel triggered for the object;
receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; and
invoking and running, after a production trigger condition of a content generated effect is satisfied, a resource package of the content generated resource, and performing content generation processing on the object to obtain the content generated effect.

2. The method according to claim 1, further comprising:
displaying, in response to a resource configuration operation, a resource parameter configuration panel, wherein the resource configuration operation is selecting the content generated resource in the resource list;
receiving parameter configuration information formed after a setting item in the resource parameter configuration panel is set.

3. The method according to claim 2, wherein the setting item in the resource parameter configuration panel comprises a content generated effect setting item and a content material setting item;
the content generated effect setting item comprises an object material acquisition setting item, an effect trigger setting item and an animation setting item for generation progress;
the content material setting item comprises at least one candidate content material required for producing the content generated effect, and generation description information associated with the at least one candidate content material is pre-packaged in the resource package.

4. The method according to claim 1, wherein, after a production trigger condition of a content generated effect is satisfied, the invoking and running a resource package of the content generated resource, and performing content generation processing on the object to obtain the content generated effect, comprises:
invoking, when it is detected that a received execution event is a pre-configured production trigger event, the resource package of the content generated resource;
determining, through running of the resource package, a selected target content material and receiving an object material introduced for the object;
uploading the target content material and the object material to a server end corresponding to the target content material, so as to form the content generated effect of the object through the server based on the target content material and the object material,
wherein acquisition approaches of the production trigger event, the target content material and the object material are all comprised in parameter configuration information formed by configuring the content generated resource.

5. The method according to claim 1, further comprising:
displaying an object material serving as the object in an effect preview display region, and displaying a progress animation of effect generation on the object material, wherein animation style information of the progress animation is comprised in parameter configuration information formed by configuring the content generated resource;
displaying, after a display condition of the content generated effect is satisfied, a generation animation from the object material to the content generated effect in the effect preview display region; and
displaying, when it is determined that the display condition of the content generated effect is not satisfied, a prompt for failed effect generation in the effect preview display region.

6. The method according to claim 5, wherein the displaying, after a display condition of the content generated effect is satisfied, a generation animation from the object material to the content generated effect in the effect preview display region, comprises:
determining, when a generated content generated effect is received within a set time after the resource package is started to run, that the display condition of the content generated effect is satisfied;
determining a content fading region in the object material, and filling the content fading region with content of the content generated effect while fading content in the content fading region; and
returning to re-execute the operations of determining content fading region, content fading and filling until the whole object material is filled with the content generated effect.

7. The method according to claim 1, wherein construction steps of the content generated resource comprises:
acquiring script content required for logic execution of the content generated effect;
constructing a resource framework with a set resource format according to acquired construction configuration information;
filling the script content into the resource framework, and packaging the resource framework filled with the script content into a resource package to form the content generated resource of the content generated effect.

8. An electronic device, comprising:
one or a plurality of processors;
a storage apparatus, configured to store one or a plurality of programs, wherein
when the one or plurality of programs are executed by the one or plurality of processors, the one or plurality of processors are caused to implement an effect production method, comprising:
displaying a created object on an effect production interface, and displaying an object production configuration panel triggered for the object;
receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface; and
invoking and running, after a production trigger condition of a content generated effect is satisfied, a resource package of the content generated resource, and performing content generation processing on the object to obtain the content generated effect.

9. The electronic device according to claim 8, wherein the method further comprises:
displaying, in response to a resource configuration operation, a resource parameter configuration panel, wherein the resource configuration operation is selecting the content generated resource in the resource list;
receiving parameter configuration information formed after a setting item in the resource parameter configuration panel is set.

10. The electronic device according to claim 9, wherein the setting item in the resource parameter configuration panel comprises a content generated effect setting item and a content material setting item;
the content generated effect setting item comprises an object material acquisition setting item, an effect trigger setting item and an animation setting item for generation progress;
the content material setting item comprises at least one candidate content material required for producing the content generated effect, and generation description information associated with the at least one candidate content material is pre-packaged in the resource package.

11. The electronic device according to claim 8, wherein, after a production trigger condition of a content generated effect is satisfied, the invoking and running a resource package of the content generated resource, and performing content generation processing on the object to obtain the content generated effect, comprises:
invoking, when it is detected that a received execution event is a pre-configured production trigger event, the resource package of the content generated resource;
determining, through running of the resource package, a selected target content material and receiving an object material introduced for the object;
uploading the target content material and the object material to a server end corresponding to the target content material, so as to form the content generated effect of the object through the server based on the target content material and the object material;
wherein acquisition approaches of the production trigger event, the target content material and the object material are all comprised in parameter configuration information formed by configuring the content generated resource.

12. The electronic device according to claim 8, wherein the method further comprises:
displaying an object material serving as the object in an effect preview display region, and displaying a progress animation of effect generation on the object material, wherein animation style information of the progress animation is comprised in parameter configuration information formed by configuring the content generated resource;
displaying, after a display condition of the content generated effect is satisfied, a generation animation from the object material to the content generated effect in the effect preview display region;
displaying, when it is determined that the display condition of the content generated effect is not satisfied, a prompt for failed effect generation in the effect preview display region.

13. The electronic device according to claim 12, wherein the displaying, after a display condition of the content generated effect is satisfied, a generation animation from the object material to the content generated effect in the effect preview display region, comprises:
determining, when a generated content generated effect is received within a set time after the resource package is started to run, that the display condition of the content generated effect is satisfied;
determining a content fading region in the object material, and filling the content fading region with content of the content generated effect while fading content in the content fading region;
returning to re-execute the operations of determining content fading region, content fading and filling until the whole object material is filled with the content generated effect.

14. The electronic device according to claim 8, wherein construction steps of the content generated resource comprises:
acquiring script content required for logic execution of the content generated effect;
constructing a resource framework with a set resource format according to acquired construction configuration information;
filling the script content into the resource framework, and packaging the resource framework filled with the script content into a resource package to form the content generated resource of the content generated effect.

15. A non-transitory computer-readable storage medium containing computer-executable instructions, wherein the computer-executable instructions, when executed by a computer processor, are used to execute an effect production method, comprising:
displaying a created object on an effect production interface, and displaying an object production configuration panel triggered for the object;
receiving a content generated effect production operation, wherein the content generated effect production operation is selecting a content generated effect production item from the object production configuration panel, the content generated effect production item is associated with a constructed content generated resource, and the content generated resource is displayed in a resource list of the effect production interface;
invoking and running, after a production trigger condition of a content generated effect is satisfied, a resource package of the content generated resource, and performing content generation processing on the object to obtain the content generated effect.

16. The non-transitory computer-readable storage medium according to claim 15, wherein the method further comprises:
displaying, in response to a resource configuration operation, a resource parameter configuration panel, wherein the resource configuration operation is selecting the content generated resource in the resource list;
receiving parameter configuration information formed after a setting item in the resource parameter configuration panel is set.

17. The non-transitory computer-readable storage medium according to claim 16, wherein the setting item in the resource parameter configuration panel comprises a content generated effect setting item and a content material setting item;
the content generated effect setting item comprises an object material acquisition setting item, an effect trigger setting item and an animation setting item for generation progress;
the content material setting item comprises at least one candidate content material required for producing the content generated effect, and generation description information associated with the at least one candidate content material is pre-packaged in the resource package.

18. The non-transitory computer-readable storage medium according to claim 15, wherein, after a production trigger condition of a content generated effect is satisfied, the invoking and running a resource package of the content generated resource, and performing content generation processing on the object to obtain the content generated effect, comprises:
invoking, when it is detected that a received execution event is a pre-configured production trigger event, the resource package of the content generated resource;
determining, through running of the resource package, a selected target content material and receiving an object material introduced for the object;
uploading the target content material and the object material to a server end corresponding to the target content material, so as to form the content generated effect of the object through the server based on the target content material and the object material;
wherein acquisition approaches of the production trigger event, the target content material and the object material are all comprised in parameter configuration information formed by configuring the content generated resource.

19. The non-transitory computer-readable storage medium according to claim 15, wherein the method further comprises:
displaying an object material serving as the object in an effect preview display region, and displaying a progress animation of effect generation on the object material, wherein animation style information of the progress animation is comprised in parameter configuration information formed by configuring the content generated resource;
displaying, after a display condition of the content generated effect is satisfied, a generation animation from the object material to the content generated effect in the effect preview display region;
displaying, when it is determined that the display condition of the content generated effect is not satisfied, a prompt for failed effect generation in the effect preview display region.

20. The non-transitory computer-readable storage medium according to claim 19, wherein the displaying, after a display condition of the content generated effect is satisfied, a generation animation from the object material to the content generated effect in the effect preview display region, comprises:
determining, when a generated content generated effect is received within a set time after the resource package is started to run, that the display condition of the content generated effect is satisfied;
determining a content fading region in the object material, and filling the content fading region with content of the content generated effect while fading content in the content fading region;
returning to re-execute the operations of determining content fading region, content fading and filling until the whole object material is filled with the content generated effect.
